(19) United States
(12) Patent Application Publication
(10) Pub. No.: US 2012/0088492 A1
(43) Pub. Date: Apr. 12, 2012

(54) CONTROL OF APPLICATIONS WHICH CAN BE CARRIED OUT BY MOBILE TERMINALS THAT CAN BE OPERATED IN A MOBILE RADIO NETWORK

(76) Inventors: Alexei Kulakov, Duesseldorf (DE); Yang Lu, Duesseldorf (DE); Mona Mustapha, Windsor (GB); Assen Golaup, Slough (GB); Armin Toepfer, Neuss (DE); Mike Hartl, Ratingen (DE); Jan Holzberg, Duesseldorf (DE)

(21) Appl. No.: 13/187,215

(22) Filed: Jul. 20, 2011

Related U.S. Application Data
(63) Continuation of application No. PCT/EP2010/000100, filed on Jan. 12, 2010.

(30) Foreign Application Priority Data
Jan. 20, 2009 (DE) 10 2009 005 529.0

(51) Int. Cl. H04W 4/00

(52) U.S. Cl. 455/419

(57) ABSTRACT

A method for a mobile terminal for a cellular mobile radio network, comprising the following steps: receiving at least one system information block (SIB) via a signaling channel, extracting at least one piece of information from the received system information block(s) (SIB) for controlling at least one application of the mobile terminal from the received system, decoding the extracted information and activating the at least one application according to the decoded information. A method for controlling applications operated by the mobile terminals is also disclosed. The network is composed of radio cells. A transceiver station forms at least one radio cell and sends a system information block via a signaling channel. The SIB comprises a pre-determinable piece of information for controlling behavior of a mobile terminal application. The invention also comprises a mobile terminal and transceiver station useful in the disclosed methods.

### CROSS-REFERENCE TO RELATED APPLICATIONS

The present application is a continuation of pending International patent application PCT/EP2010/000100 filed on Jan. 12, 2010 which designates the United States and claims priority from German patent application 10 2009 005 529.0 filed on Jan. 20, 2009, the content of which is incorporated herein by reference.

### FIELD OF THE INVENTION

The present invention relates to a method for controlling applications which can be carried out by mobile terminals that can be operated in a mobile radio network having a cellular network structure composed of radio cells.

Furthermore, the present invention relates to a mobile terminal for the use in a mobile radio network having a cellular network structure composed of radio cells, in particular according to a UMTS and/or LTE radio network standard, which is designed and/or adapted to carry out at least a part of the method according to the invention.

A further subject of the present invention is a transceiver station in a mobile radio network having a cellular network structure composed of radio cells, in particular according to a UMTS and/or LTE radio network standard, which is designed and/or adapted to carry out at least a part of the method according to the invention.

### BACKGROUND OF THE INVENTION

In mobile terminals, in particular mobile phones that are known in the state of the art and can be operated in mobile radio networks, in particular incoming calls and/or incoming messages of a message service of a mobile radio network, for example so called SMS and/or MMS, will be reproduced acoustically as communication information by means of ringing tones or optically as a signal which represents the communication information by means of logos and/or videos by the mobile terminal within the scope of applications carried out by the mobile terminal. Herein, usually the volume, the number of signal repetitions and the like signal parameters of signals which represent communication information can be individually controlled. Furthermore, corresponding mobile terminals are meanwhile adapted to be used as reproduction device of acoustic and/or optical data, in particular audio and/or video data or information according to MPEG (MPEG: Moving Picture Experts Group).

There are numerous situations in daily use, in which the reproduction of signals which represent communication information and/or the reproduction of audio and/or video data by means of the mobile terminal is disturbing or is felt to be troublesome, in particular in meetings, in the theatre, in the cinema, in school or the like situations. The same is also true for other applications which are carried out or can be carried out by a mobile terminal. Usually, mobile terminals offer the possibility—inter alia for this purpose—to modify the allocation and reproduction of signals which represent communication information or to generally suppress a reproduction of acoustic signals by means of the mobile terminal, for example within the scope of a so called “Mute Modus” in which the acoustic reproduction of signals by the mobile terminal is switched off. Furthermore, it is possible for the user of a mobile terminal to completely switch off the mobile terminal by himself. Herein, it is in particular disadvantageous that the respective user of a mobile terminal has to realize a corresponding modification with respect to the reproduction of signals personally by means of the mobile terminal and that the user can sometimes forget to do this. The same is true for a reactivation of the application of the mobile terminal after a previous deactivation of the application.

Based upon this state of the art it is the subject of the present invention to improve the control of applications which can be carried out by mobile terminals that can be operated in a mobile radio network having a cellular network structure composed of radio cells, in particular with respect to a reproduction of signals by means of mobile terminals.

### SUMMARY OF THE INVENTION

For technically achieving this aim the present invention proposes a method to be carried out in a mobile terminal for a cellular mobile radio network, comprising the following steps:

receiving at least one system information block (SIB) via a signaling channel,

extracting at least one piece of information from the received system information block (SIB) for controlling at least one application of the mobile terminal,

decoding the extracted piece of information and

activating the at least one application according to the decoded piece of information.

According to the invention, a method for controlling applications which can be carried out by mobile terminals that can be operated in a mobile radio network having a cellular network structure composed of radio cells is thus provided, wherein a mobile terminal in a radio cell of the mobile radio network advantageously receives at least one system information block (SIB) via a signaling channel for the transmission of system information, which system information block (SIB) comprises at least one pre-determinable piece of information for controlling the behavior of at least one application of a mobile terminal, extracts the at least one piece of information for controlling the at least one application of a mobile terminal from the received system information block (SIB), decodes the extracted piece of information for controlling the behavior of the at least one application of a mobile terminal and activates the at least one application of the mobile terminal according to the decoded piece of information for controlling the behavior of the at least one application of a mobile terminal.

Advantageously, the invention uses the knowledge that an improved control of applications which can be carried out by mobile terminals that can be operated in a mobile radio network having a cellular network structure composed of radio cells can be achieved by introducing, according to the invention, at least one pre-determinable piece of information for controlling the behavior of at least one application of a mobile terminal in a system information block (SIB) which is realized via a signaling channel for the transmission of system information between a mobile terminal and a transceiver station which forms at least one radio cell of the mobile radio network. Thus, the hitherto known standards for system information blocks (SIBs) which are for example described in the 3GPP standard 25.331 and 36.331 are modified according to the invention, in particular with respect to a use in mobile radio networks according to a UMTS and/or LTE radio network standard.

Thanks to the method according to the invention an improvement with respect to the control of applications which can be carried out by mobile terminals that can be operated in a mobile radio network having a cellular network structure composed of radio cells, in particular with respect to the functionality of a reproduction of signals by the mobile terminal can be achieved, in particular since according to the invention the mobile radio network controls the at least one application of the mobile terminal in dependence on the presence of the mobile terminal in the advantageously at least one pre-determinable radio cell of the mobile radio network. Thus, it can be advantageously assured in a partially automatized way that a user of the mobile terminal in particular does not erroneously forget the activation of a mute modus of the loudspeaker of the mobile terminal or another application of the mobile terminal. According to the invention, the mobile terminal is herein advantageously always actively registered in the mobile radio network and can be further used according to the activated application control.

According to an advantageous proposal of the invention, the mobile terminal receives the at least one system information block (SIB) upon entry or registration in a radio cell of the mobile radio network. According to the invention, the at least one system information block (SIB) will be received according to the signaling of the at least one system information block (SIB) provided by the mobile radio network, i.e. in particular continuously or in pre-determinable time intervals and/or repetitions, when the mobile terminal is present in the radio cell, and will be accordingly sent by a transceiver station of the mobile radio network which forms the at least one radio cell. If the radio cell changes, the mobile terminal will advantageously receive corresponding system information blocks of the new radio cell and will activate applications according to the predefinitions or settings given for this radio cell. Thus, a further improvement with respect to an at least partially automatic control of applications of the mobile terminal is achieved according to the invention, in particular with respect to the handling of the mobile terminal for the user.

Another embodiment of the invention proposes a method for controlling applications which can be carried out by mobile terminals that can be operated in a mobile radio network having a cellular network structure composed of radio cells, wherein a transceiver station of the mobile radio network which forms at least one radio cell of the mobile radio network sends at least one system information block (SIB) via a signaling channel for the transmission of system information, which system information block (SIB) comprises at least one pre-determinable piece of information for controlling the behavior of at least one application of a mobile terminal.

According to another advantageous proposal of the invention, the piece of information for controlling the behavior of at least one application of a mobile terminal will be sent to selectable mobile terminals in the radio cell of the mobile radio network or to all mobile terminals in the radio cell of the mobile radio network.

Advantageously, the at least one pre-determinable piece of information for controlling the behavior of at least one application of a mobile terminal is subject to time-dependent pre-definitions respectively specifications. Thus, the at least one application of the mobile terminal can be for example activated at pre-determinable times, e.g. in conference meetings or similar situations. Advantageously, corresponding appointments are generated from a time scheduling functionality of the mobile terminal in an at least partially automatic way, are deposited or gathered by the mobile radio network and used by the mobile radio network for a control of applications according to the invention.

In another embodiment according to the invention the at least one pre-determinable piece of information for controlling the behavior of at least one application of a mobile terminal is subject to pre-definitions respectively specifications rooted in the person of the user of the mobile terminal. A preferred embodiment of the invention is characterized by a consideration of the using behavior of the user of the mobile terminal for the pre-definitions rooted in the person of the user of the mobile terminal. Pre-definitions respectively specifications rooted in the person of the user of the mobile terminal are advantageously using preferences and/or the using behavior of the user of the mobile terminal, services in the mobile radio network which the user has subscribed to and/or setup, in particular message services of the mobile radio network provider and/or corresponding third providers or the like.

In another advantageous embodiment of the invention the at least one pre-determinable piece of information for controlling the behavior of at least one application of a mobile terminal is determined by the belonging of the user of the mobile terminal to a group of users of mobile terminals which can be operated in the mobile radio network, which group has been set up by the mobile radio network. Advantageously, the at least one pre-determinable piece of information for controlling the behavior of at least one application of a mobile terminal is pre-determined by at least one functionality state of a mobile terminal of at least one member of the group of the user of the mobile terminal. Thus, the handling of an application control according to the invention will be improved according to the invention, in particular since for example in department meetings with the members of the department as a group or in school with the teacher and the pupils as a group, the leader of the department or the leader of the meeting or the teacher in school can activate the respectively desired or required applications of the mobile terminals of the members of the group. Thus, the at least one member of the group quasi takes a so called master function for the other members of the group with respect to the application control of the mobile terminals and the other members of the group accordingly take a so called “slave function” with respect to a hierarchic administration regarding a control of applications of the mobile terminals of the members of the group.

According to an advantageous proposal of the invention, the at least one application of a mobile terminal is the optical and/or acoustic display functionality of an optical and/or acoustic display unit of the mobile terminal.

According to another advantageous proposal of the invention, the at least one application of a mobile terminal is the optical and/or acoustic input functionality of an optical and/or acoustic input unit of the mobile terminal.

A preferred embodiment of the invention provides that the signaling channel is a broadcast control channel.

In another advantageous embodiment of the invention the at least one piece of information for controlling the behavior of at least one application of a mobile terminal will be pre-determined by the mobile radio network provider and/or by a provider offering services in the mobile radio network.

Advantageously, the at least one pre-determinable piece of information for controlling the behavior of at least one application of a mobile terminal will be managed and/or administrated in a data base, preferably in a data base of the mobile radio network and/or in a data base that can be connected to the mobile radio network. Advantageously, the data base will be managed and/or administrated by the user, the mobile radio network provider and/or a member of the group, in particular the leader of the group, advantageously via the internet and/or a dialogue oriented interface of the mobile radio network.

For technically solving the initially mentioned problem, the present invention furthermore proposes a mobile terminal for the use in a mobile radio network having a cellular network structure composed of radio cells, in particular according to a UMTS and/or LTE radio network standard, which is characterized in that this one is configured to receive at least one system information block (SIB) which comprises at least one pre-determinable piece of information for controlling the behavior of at least one application of the mobile terminal via a signaling channel for the transmission of system information, to extract the at least one piece of information for controlling the behavior of the at least one application of the mobile terminal from the received system information block (SIB), to decode the extracted piece of information for controlling the behavior of the at least one application of a mobile terminal and to activate the at least one application of the mobile terminal according to the decoded piece of information for controlling the behavior of the at least one application of a mobile terminal.

The mobile terminal is advantageously designed and/or adapted to carry out at least a part of a method according to the invention.

A further subject of the present invention is a network node, preferably a transceiver station in a mobile radio network having a cellular network structure composed of radio cells, in particular according to a UMTS and/or LTE radio network standard, which is characterized in that this one is configured to send at least one system information block (SIB) which comprises at least one pre-determinable piece of information for controlling the behavior of at least one application of a mobile terminal via a signaling channel for the transmission of system information.

The network node, preferably the transceiver station is advantageously designed and/or adapted to carry out at least a part of a method according to the invention.

### BRIEF DESCRIPTION OF THE DRAWINGS

Further details, characteristics and advantages of the invention will be explained in more detail in the following by means of the exemplary embodiment of the invention which is represented in the figure of the drawing. Herein:

FIG. 1 is a schematic diagram of a universal exemplary embodiment of an application control according to the invention.

### DETAILED DESCRIPTION OF THE INVENTION

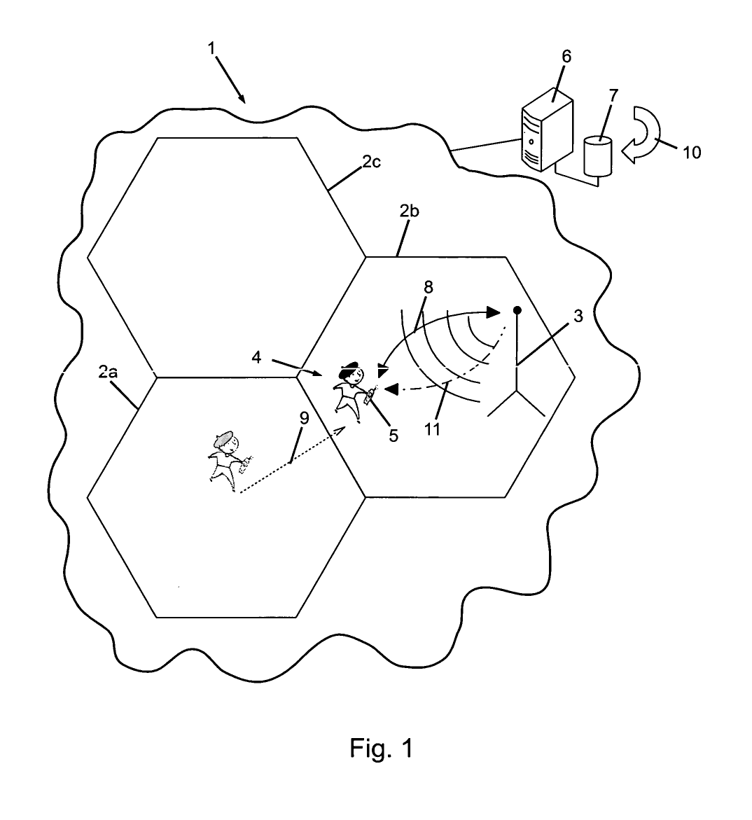

FIG. 1 shows a mobile radio network 1 having a cellular network structure composed of radio cells 2a, 2b, 2c. In the present case, the mobile radio network 1 is a mobile radio network according to a UMTS and/or LTE radio network standard. The mobile radio network 1 is symbolically represented by a cloud in FIG. 1. The mobile radio network 1 comprises other different devices and/or systems which are not separately represented in FIG. 1 for reasons of clarity. Herein, the radio cells 2a, 2b, 2c are in particular formed and operated by transceiver stations 3 of the mobile radio network, of which one is exemplarily represented in FIG. 1 for reasons of clarity.

FIG. 1 further shows a user 4 with a mobile terminal 5 that can be operated in the mobile radio network 1. The mobile terminal 5 is a mobile phone in the present case.

In the present case the mobile radio network 1 provides a computing apparatus (server) 6 which comprises a database 7 or can be connected to the database 7. The computing apparatus 6 comprising the database 7 is placed in the mobile radio network 1 in the present case or can be connected to this one. For controlling applications which can be carried out or are carried out by the mobile terminal 5 according to the invention, the at least one pre-determinable piece of information for controlling the behavior of at least one application of a mobile terminal 5 of the user 4 can be deposited in the database 7 provided by the mobile radio network by another, here not represented person and/or device, for example a leader of a group. Herein, the database 7 can be managed and/or administrated by another, here not represented person and/or device.

If the mobile terminal 5 of the user 4 is present in at least one pre-determinable radio cell of the mobile radio network 1, the mobile terminal 5 will receive at least one system information block (SIB) via a signaling channel, will then extract at least one piece of information for controlling at least one application of the mobile terminal 5 from the received system information block (SIB), will decode the extracted piece of information and will activate at least one application of the mobile terminal 5 according to the decoded piece of information.

In the present exemplary embodiment represented in FIG. 1 the system information block (SIB) which is sent by the transceiver station 3 via a signaling channel will be automatically received if the availability and the radio coverage of the mobile terminal 5 of the user 4 are given in the radio cell 2b. Herein, FIG. 1 shows how the user 4 with his mobile terminal 5 changes from the radio cell 2a into the radio cell 2b. In FIG. 1 the change of the radio cell by the user 4 or the mobile terminal 5 of the user 4 from the radio cell 2a of the mobile radio network 1 into the radio cell 2b of the mobile radio network 1 is symbolically represented by the user 4 represented in light grey with the mobile terminal 5 and the dotted arrow referenced by the reference numeral 9.

The change of radio cell will be gathered by the mobile radio network 1, in the present case by the availability of the mobile terminal 5 of the user 4 in the radio cell 2b (in FIG. 1 symbolically represented by the double arrow referenced by the reference numeral 8). Thereupon, the transceiver station 3 of the mobile radio network 1 sends a system information block (SIB)—in the present case by means of cell broadcast—via a signaling channel for the transmission of system information, which system information block (SIB) comprises at least one pre-determinable piece of information for controlling the behavior of at least one application of the mobile terminal 5. Herein, the piece of information for controlling the behavior of at least one application of the mobile terminal 5 will be determined before or meanwhile by a query of the database 7 by the mobile radio network (in FIG. 1 symbolically represented by the arrow referenced by the reference numeral 10).

The mobile terminal 5 in the radio cell 2b of the mobile radio network 1 receives the at least one system information block (SIB) via a signaling channel for the transmission of system information, which system information block (SIB) comprises at least one pre-determinable piece of information for controlling the behavior of at least one application of the mobile terminal 5 (in FIG. 1 symbolically represented by the arrow referenced by the reference numeral 11). The mobile terminal 5 then extracts the at least one piece of information for controlling the behavior of at least one application of the mobile terminal 5 from the received system information block (SIB). Then, the mobile terminal 5 decodes the extracted piece of information for controlling the behavior of at least one application of the mobile terminal 5 and activates the at least one application of the mobile terminal 5 according to the decoded piece of information for controlling the behavior of at least one application of the mobile terminal 5. In the present case, the application is exemplarily in particular adapted to activate the mute modus of a loudspeaker of the mobile terminal 5 for incoming calls and/or messages.

Herein, the system information comprises a control information block for controlling the activation of the at least one application of the mobile terminal, which control information block is advantageously integrated or contained in the system information as an activation bit or flag. In case of a change of radio cell the transceiver station which is then responsible for the new radio cell will advantageously send a corresponding activation bit or flag in respectively with the system information block (SIB) which has been sent by this transceiver station via a signaling channel. Herein, the applications which are respectively valid or desired in this radio cell will then advantageously be activated automatically according to the invention by means of the mobile terminal.

The exemplary embodiment of the invention which has been represented in the figure of the drawing and has been described in connection with this one only serves for explanation of the invention and is not limiting to this one.

1. A method to be carried out in a mobile terminal for a cellular mobile radio network, comprising the following steps:
receiving at least one system information block via a signaling channel,
extracting at least one piece of information from the received system information block (SIB) for controlling at least one application of the mobile terminal,
decoding the extracted piece of information, and
activating the at least one application according to the decoded piece of information.

2. The method according to claim 1, wherein the mobile terminal receives the at least one system information block upon entry or registration in a radio cell of the mobile radio network.

3. A method for controlling applications, which can be carried out by mobile terminals that can be operated in a mobile radio network having a cellular network structure composed of radio cells, wherein a transceiver station of a mobile radio network that forms at least one radio cell of the mobile radio network sends at least one system information block via a signaling channel for transmission of system information, and said system information block comprises at least one pre-determinable piece of information for controlling behavior of at least one application of a mobile terminal.

4. The method according to claim 3, wherein the piece of information for controlling the behavior of at least one application of a mobile terminal is sent to selectable mobile terminals in the radio cell of the mobile radio network or to all mobile terminals in the radio cell of the mobile radio network.

5. The method according to claim 1, wherein the at least one pre-determinable piece of information for controlling the behavior of at least one application of a mobile terminal is subject to time-dependent pre-definitions.

6. The method according to claim 1, wherein the at least one pre-determinable piece of information for controlling the behavior of at least one application of a mobile terminal is subject to pre-definitions rooted for a user of the mobile terminal.

7. The method according to claim 6, wherein a consideration of the using behavior of the user of the mobile terminal for the pre-definitions is rooted for the user of the mobile terminal.

8. The method according to claim 1, wherein the at least one pre-determinable piece of information for controlling the behavior of at least one application of a mobile terminal is determined by the user of the mobile terminal belonging to a group of users of mobile terminals that can be operated in the mobile radio network, and wherein said group has been set up by the mobile radio network.

9. The method according to claim 8, wherein the at least one pre-determinable piece of information for controlling the behavior of at least one application of a mobile terminal is pre-determined by at least one functionality state of a mobile terminal of at least one member of the group of the user of the mobile terminal.

10. The method according to claim 1, wherein the at least one application of a mobile terminal is the optical and/or acoustic display functionality of an optical and/or acoustic display unit of the mobile terminal.

11. The method according to claim 1, wherein the at least one application of a mobile terminal is the optical and/or acoustic input functionality of an optical and/or acoustic input unit of the mobile terminal.

12. The method according to claim 1, wherein the signaling channel is a broadcast control channel.

13. The method according to claim 1, wherein the at least one piece of information for controlling the behavior of at least one application of a mobile terminal is pre-determined by at least one of the mobile radio network provider and a provider offering services in the mobile radio network.

14. The method according to claim 1, wherein the at least one pre-determinable piece of information for controlling the behavior of at least one application of a mobile terminal is managed or administrated in a data base.

15. A mobile terminal for the use in a mobile radio network having a cellular network structure composed of radio cells, in particular according to a UMTS and/or LTE radio network standard, said terminal configured to:
receive at least one system information block comprising at least one pre-determinable piece of information for controlling the behavior of at least one application of the mobile terminal via a signaling channel for the transmission of system information,
extract the at least one piece of information for controlling the behavior of the at least one application of the mobile terminal from the received system information block,
decode the extracted piece of information for controlling the behavior of the at least one application of a mobile terminal, and
activate the at least one application of the mobile terminal according to the decoded piece of information for controlling the behavior of the at least one application of a mobile terminal.

16. (canceled)

17. A transceiver station in a mobile radio network having a cellular network structure composed of radio cells, in particular according to a UMTS and/or LTE radio network standard, said station configured to send at least one system information block that comprises at least one pre-determinable piece of information for controlling behavior of at least one application of a mobile terminal via a signaling channel for transmission of system information.

18. The transceiver station according to claim 17 further configured to receive at least one system information block via a signaling channel, extract at least one piece of information from the received system information block for controlling at least one application of the mobile terminal, decode the extracted piece of information, and activate the at least one application according to the decoded piece of information.

19. The method of claim 14, wherein the data base of the mobile radio is connected to the mobile radio network.
